(19) United States
(12) Patent Application Publication
(10) Pub. No.: US 2009/0094328 A1
(43) Pub. Date: Apr. 9, 2009

(54) System and Methods for Technology Evaluation and Adoption

(75) Inventors: Brian D. Goodman, Southbury, CT (US); Amy Chow, Norwalk, CT (US); John W. Rooney, New Fairfield, CT (US); Christopher D. Wyble, Poughkeepsie, NY (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/866,429

(22) Filed: Oct. 3, 2007

(51) Int. Cl. G06F 15/16

(52) U.S. Cl. 709/204

(57) ABSTRACT

A method for technology evaluation and adoption includes proposing a new technology and allowing at least one group to use the new technology. The at least one group provides feedback through at least one collaboration tool. The at least one group's use of the new technology is evaluated and at least one value based upon the evaluation is calculated. The new technology may be directed to at least one of new software, programs, services, or business processes.

### I. FIELD OF THE INVENTION

The present invention relates to a system and methods to facilitate technology evaluation and adoption within an enterprise, such as a corporation, university, or government agency.

### II. BACKGROUND OF THE INVENTION

Innovation represents the single largest opportunity for companies to differentiate their business. However, there are several disadvantages to current approaches to technology evaluation and adoption, also known as innovation management.

Formal innovation management systems require innovators to prove that an idea is worthy for development and then proceed through several lengthy, defined phases. Accordingly, by the time funding is secured and a solution is deployed, the constantly changing needs of the business often render an innovation inadequate or untimely. In addition, many information technology projects are based on false projections of cost savings rather than business strategy. Formal management systems are therefore too rigorous in today's business environment.

U.S. Pat. No. 6,452,613 discloses an apparatus and method for an automated invention submission and scoring tool for evaluating invention submissions. The system comprises a server system and a plurality of server systems. The server system presents submission questionnaires over a networked connection to submitters at user systems. The user completes the questionnaires, which are returned to the server system for processing. The server system processes the answers to provide a quantified evaluation of the submission based on patentability and at least one other parameter, such as impact or value. An evaluator at an evaluator system can view a presentation of the quantified assessment of the invention submission. The evaluator can also view the results of multiple invention submissions on a status overview page. Links between the status overview page, individual questionnaires, and individual assessment presentations are provided.

U.S. Pat. No. 6,961,756 discloses an application that allows employees to submit suggestions and ideas for improving how a company does business. An embodiment of the invention supports multiple points of entry, which can include an entry portal, which is a single point of entry to a Web application; a point of entry for employees within a specific business unit in a larger entity for submission of suggestions related to the business unit; a point of entry for motivated submitters with an idea about how to change the company's business; a central point of entry for ideas and suggestions; and a point of entry for ideas on improving a specific aspect of the company, for example the company's use of the Internet.

U.S. Patent Application Publication No. 2004/0181417 discloses systems and techniques to facilitate collaborative development of product definitions that allow convenient and efficient identification and evaluation of product innovation ideas. In one implementation, the technique includes receiving product innovation ideas via a network and storing the product innovation ideas. The stored product innovation ideas are displayed for review by a user, and the user may send an indication via the network of one or more selected product innovation ideas. Web-based collaboration among an evaluation team comprising a plurality of members provides a mechanism for evaluating the at least one user-selected product innovation idea.

U.S. Patent Application Publication No. 2005/0240428 discloses a system for automating and managing an intellectual property environment in an organization over a network of computers. The system has user interface displays on each of the computers, and includes computer readable code devices in computer readable media for displaying, and methods for displaying, a number of management tools in the form of frames or screens or pages that provide for users submitting and sharing innovations, innovation analysis, finding experts for collaboration and evaluation of innovations, highlighting, spotlighting and showcasing innovations and innovation development, creating and responding to innovation challenges, and timelining, tasking and workflow peculiar to innovation management in an organization.

Instead of simply submitting new ideas for review and analysis, there remains a need for accelerating technology innovation within an enterprise by streamlining the ability of an innovator to submit a new technology, encouraging actual adoption and use of the new technology, facilitating communication between the adopters of the new technology and the innovator, and evaluating feedback from adopters of the new technology to gauge its value.

### III. SUMMARY OF THE INVENTION

According to an aspect of the invention, a method is provided for technology evaluation and adoption. A new technology is proposed. At least one group is allowed to use the new technology and provides feedback through at least one collaboration tool. The at least one group's use of the new technology is evaluated and at least one value is calculated based upon the evaluation.

According to another aspect of the invention, a method is provided for evaluating technology. An innovator proposes an offering for a new technology through a website. A team reviews the offering and, upon approval, provides a webpage directed to the offering. A group of first adopters accesses and uses the new technology and provides feedback to the innovator through at least one collaboration tool. The first adopters' use of the offering is evaluated. At least one numerical value is calculated based upon the evaluation of the first adopters.

According to another aspect of the invention, method is provided for evaluating technology. An innovator submits an offering for a new technology through a website. A team reviews the offering and, upon approval, provides a webpage directed to the offering. A group of first adopters accesses and uses the new technology and provides feedback to the innovator through at least one collaboration tool. The first adopters' use of the offering is evaluated. A group of early adopters accesses and uses the new technology and provides feedback to the innovator through at least one collaboration tool. The early adopters' use of the offering is evaluated. A single value is calculated based upon the evaluation of the first adopters and the early adopters.

According to an aspect of the invention, a system is provided for technology evaluation and adoption. The system includes an agent for providing a website and allowing access to at least one offering for a new technology; at least one client; a search engine; and at least one database for storing at least one of input, edits, lists or reports generated by use of the website.

According to another aspect of the invention, a computer program product is provided comprising a computer useable medium having a computer readable program. When executed on a computer, the computer readable program causes the computer to propose a new technology; allow at least one group to use the new technology and provide feedback through at least one collaboration tool; evaluate the at least one group's use of the new technology; and calculate at least one value based upon the evaluation.

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

Given the following enabling description of the drawings, the system and methods should become evident to a person of ordinary skill in the art.

### IV. BRIEF DESCRIPTION OF THE DRAWINGS

FIG. 1 is a screen display showing a main home page of a technology adoption program according to an embodiment of the invention.

FIG. 2 is a screen display showing an information page for a technology adoption program according to an embodiment of the invention.

FIG. 3 is a screen display showing a basic information page for an offering according to an embodiment of the invention.

FIG. 4 is a screen display showing a team page for an offering according to an embodiment of the invention.

FIG. 5 is a screen display showing support materials page for an offering according to an embodiment of the invention.

FIG. 6 is a screen display showing a media and related links page for an offering according to an embodiment of the invention.

FIG. 7 is a screen display showing a news and notices page for an offering according to an embodiment of the invention.

FIG. 8 is a screen display of a metrics and services page for an offering according to an embodiment of the invention.

FIG. 9 is a screen display for an innovation enablers page according to an embodiment of the invention.

FIG. 10 is a screen display showing an offering management page according to an embodiment of the invention.

FIG. 11A is a screen display showing a browse offerings page according to an embodiment of the invention.

FIG. 11B is a screen display showing an offering page according to an embodiment of the invention.

FIG. 11C is a screen display showing a personal profile page according to an embodiment of the invention.

FIG. 11D is a screen display showing a forum page according to an embodiment of the invention.

FIG. 12 is a screen display showing an events page according to an embodiment of the invention.

FIG. 13 is a screen display showing a scorecard home page according to an embodiment of the invention.

FIG. 14 is a screen display showing a listing of offerings ready for scorecard evaluation according to an embodiment of the invention.

FIG. 15 is a screen display showing a scorecard according to an embodiment of the invention.

FIG. 16 is a screen display showing a list of offerings having completed scorecard evaluations according to an embodiment of the invention.

FIG. 17 is a screen display showing an offering comparison according to an embodiment of the invention.

FIG. 18A is a screen display showing a partial survey according to an embodiment of the invention.

FIG. 18B is a screen display showing a partial survey according to an embodiment of the invention.

FIG. 19 is a screen display showing an administration home page according to an embodiment of the invention.

FIG. 20 is a screen display showing an administration management page according to an embodiment of the invention.

FIG. 21 is a screen display showing an offering statistics page according to an embodiment of the invention.

FIG. 22 is a screen display showing a users statistics page according to an embodiment of the invention.

FIG. 23 is a screen display showing an offering segmentation reports page according to an embodiment of the invention.

FIG. 24 is a screen display showing a dynamic offerings reports page according to an embodiment of the invention.

FIG. 25 is a block diagram of a system according to an embodiment of the invention.

FIG. 26 is a block diagram of the exemplary agent of FIG. 25.

### V. DETAILED DESCRIPTION OF THE DRAWINGS

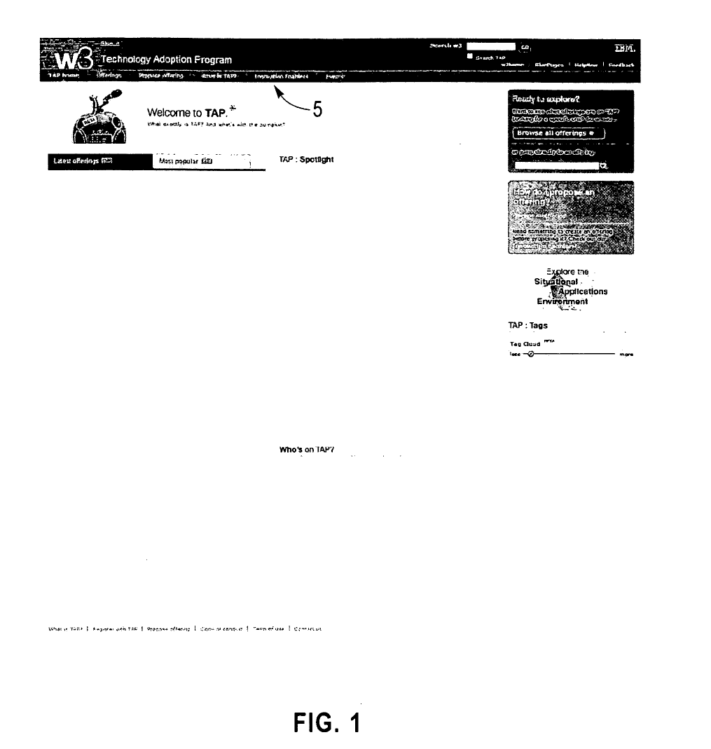

FIGS. 1-26 show a system and methods to facilitate technology evaluation and adoption within an enterprise, such as a corporation, university, or government agency. According to the present invention, the system and methods for technology evaluation and adoption accelerate innovation by reducing the time required to introduce a new technology and by increasing the number of development iterations. The technology adoption process or program (TAP) of the present invention removes the barriers of a formal management process, for example, by not requiring complex voting, budget or return-on-investment calculations, or detailed action plans.

### I. Technology Adoption Community

According to the present invention, the technology adoption process or program (TAP) provides a community for individuals involved in innovation. The community includes at least one of Innovators, First Adopters, Early Adopters, TAP Team, TAP Agents, or TAP partners.

Innovators, or inventors, are individuals who are not satisfied with the status quo and seek to develop new technology, for example, new software, programs, services, business processes, or other solutions. Innovators present their new technologies as “Offerings” to the rest of the TAP community.

First Adopters are a group of core adopters of an Offering. In embodiments, First Adopters may comprise a group of from about 5 to about 100 individuals. First Adopters are tolerant of problems and bugs in new technologies are quick to provide feedback in early versions of an Offering. By providing early feedback and stimulating discussion, First Adopters help lead a pack of Early Adopters to adopt and accelerate development of an Offering.

In embodiments, the group of First Adopters may be chosen by sending out an enterprise-wide email, soliciting individuals for the group. The first predetermined number of individuals to respond are grouped together as First Adopters and are given access to at least one Offering. Feedback regarding their experiences with the at least one Offering is solicited. In certain embodiments, First Adopters are given access to a new Offering each week which they are responsible to try and evaluate.

Early Adopters are individuals who are passionate about testing new Offerings. Early Adopters are a larger and more diverse group than First Adopters and may number in the hundreds or thousands. The Early Adopters choose which Offerings they want to use. Like the First Adopters, the Early Adopters provide feedback to the Innovator about their experiences with the Offering.

The TAP team helps the technology adoption lifecycle run smoothly by providing at least one of services, infrastructure, tools, communications, or value assessment. The TAP team may comprise at least one of employees or experts in different departments or business units of an enterprise. In embodiments, the TAP team may include people from departments such as consulting, project management, technology, infrastructure, marketing, communications, design, or a legal department.

TAP agents are a group of at least one of employees or experts that provide Innovators with guidance on how to mature Offerings for production deployment. TAP Partners serve as advocates of an Offering by identifying executive support and sponsorship of Offerings with high value potential.

### II. Technology Adoption Lifecycle

The lifecycle of an Offering in the technology adoption process has several phases. In preferred embodiments, the technology adoption process utilizes a website having multiple interlinked web pages and is described in detail below.

A. Propose Offering

Innovators may propose or submit a new technology or Offering through the website. The website offers a self-service process for Innovators to propose and manage their Offerings. During the proposal process, an Innovator is asked for several details about the Offering. Once submitted, the proposed Offering is reviewed by the TAP team. When an Offering is approved, an Offering-specific webpage is provided by adding a webpage to the website.

B. Use of Offering and Feedback

At least one group (e.g., First Adopters) read about the Offering and access the Offering, for example, by downloading the Offering. According to the present invention, the at least one group uses the Offering and provides feedback to the Innovator through at least one collaboration tool. In embodiments, a first group (First Adopters) and a second group (Early Adopters) access the new technology/Offering, use the new technology/Offering, and provide feedback to the Innovator through at least one collaboration tool.

C. Value Framework

According to the present invention, an Offering is evaluated. In embodiments, a first group's (e.g., First Adopters) use the technology is evaluated, for example, by providing the first group with a scorecard. At least one value is calculated based upon the results of the scorecard. The at least one value may be numeric, alphanumeric, or alphabetic.

In certain embodiments, a second group's (e.g., Early Adopters) use of the technology is also evaluated, for example, by providing the second group with a survey. A single value (early adoption value) is calculated by aggregating and weighting the evaluations of the first and second group's use of the Offering. The single value may be numeric, alphanumeric, or alphabetic. The at least one numerical value and/or early adoption value helps determine an Offering's potential value and helps provide recommendations for an Offering's graduation from TAP. A time limit may be set for an Offering's participation in TAP.

D. Graduation

Graduation is the movement of an Offering from TAP to the next step in the lifecycle. The next step depends upon the evaluation of the Offering by at least one of the TAP team, TAP Agents, or TAP Partners. The Offering may move quickly into production, may return to development only to come back through TAP in the future, or may be abandoned.

### III. Technology Adoption Website

The technology adoption lifecycle will now be described with respect to use of the website.

A. Main Webpage

As illustrated in FIG. 1, the main webpage (Home) comprises tabs or menus 5 linking to separate webpages of the website. In certain embodiments, the tabs or menus may include, but are not limited to, at least one of Home, What is TAP?, Offerings, Propose Offering, Innovation Enablers, Events, Offering Management, Scorecard, or Administration as described below.

B. What is TAP? Webpage

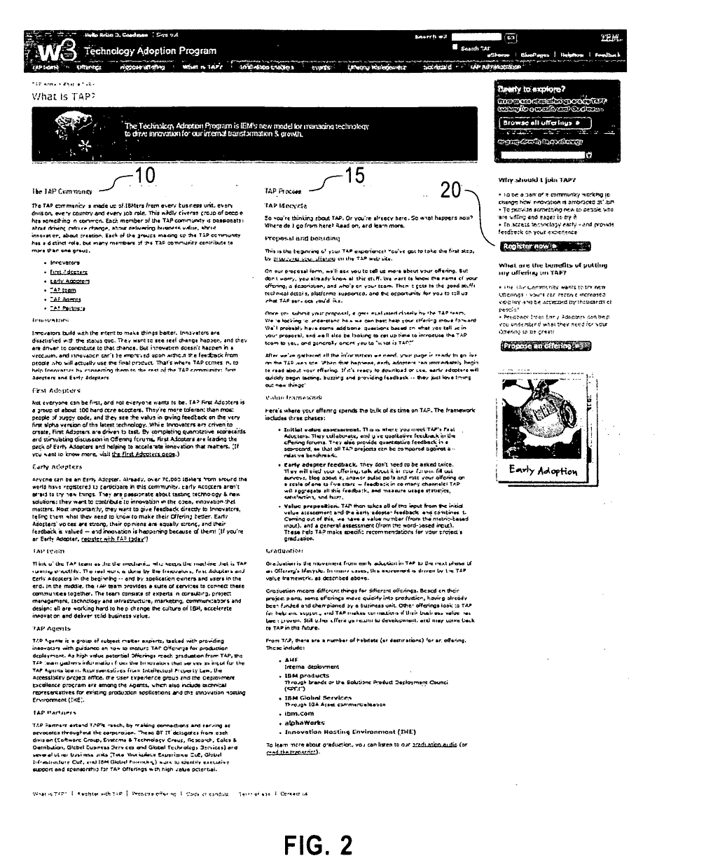

As illustrated in FIG. 2, a “What is TAP?” webpage provides information about the TAP community 10 and TAP lifecycle 15 to interested individuals of an enterprise. The “What is TAP?” webpage may be used to answer Frequently Asked Questions (FAQ). In embodiments, this webpage allows individuals to register to join the TAP community 20. However, registration may occur on other webpages or on a dedicated Registration webpage. In embodiments, registered individuals may also be given the opportunity to opt-out of TAP.

C. Propose Offering Webpage

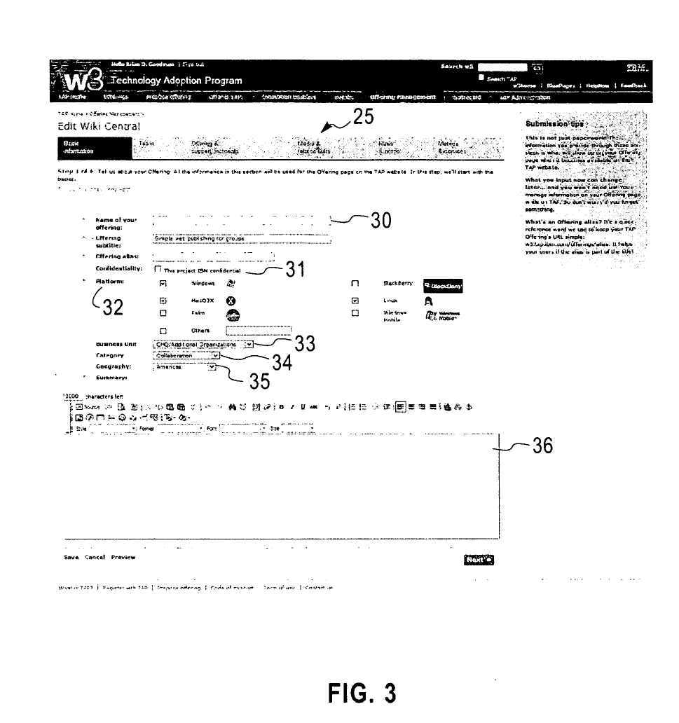

The Propose Offering webpage comprises at least one tab or menu to facilitate the description and submission of an Innovator's Offering, 25 (FIG. 3). The at least one tab or menu may link to a separate webpage of the website. In certain embodiments, the at least one tab or menu may be directed to at least one of Basic Information, Team, Support Materials, Related Links, News/Notes, or Metrics and Services.

As illustrated in FIG. 3, a Basic Information webpage allows an Innovator to provide basic information about a proposed Offering. Basic Information may include, but is not limited to, at least one of name of the Offering 30, whether or not the Offering is confidential 31, the software platform used 32 (e.g., Windows, Mac OSX, Linux), the business unit or organization related to the Offering 33, the technology category of the Offering 34 (e.g., collaboration, publishing, finance), the geographical location for the Offering 35, or a summary of the Offering 36.

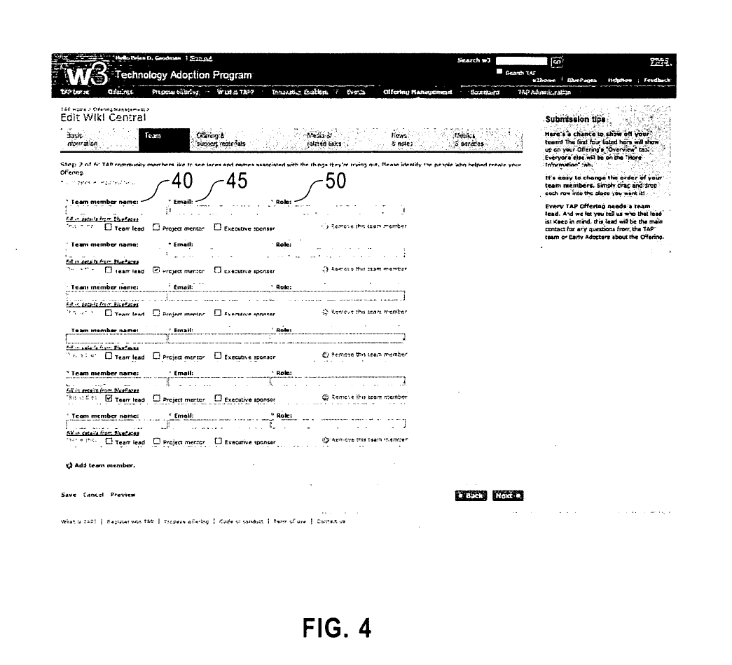

As illustrated in FIG. 4, a Team webpage allows an Innovator to provide information for individuals associated with a proposed Offering (i.e., the Innovator Team). For example, such information may include, but is not limited to, at least one of a team member's name 40, contact information 45 (e.g., e-mail address, phone), or role 50 (e.g., team leader, project mentor, executive sponsor).

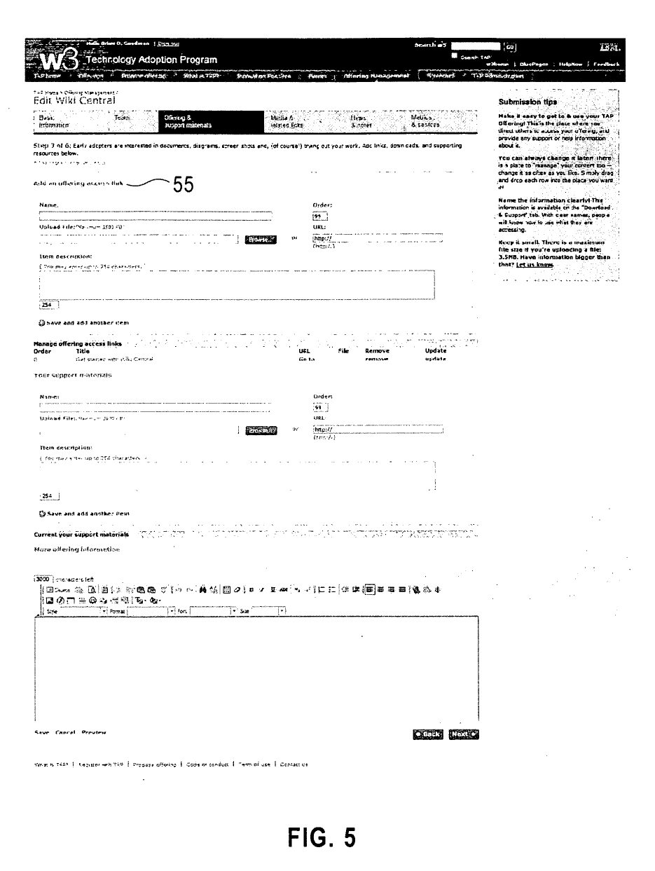

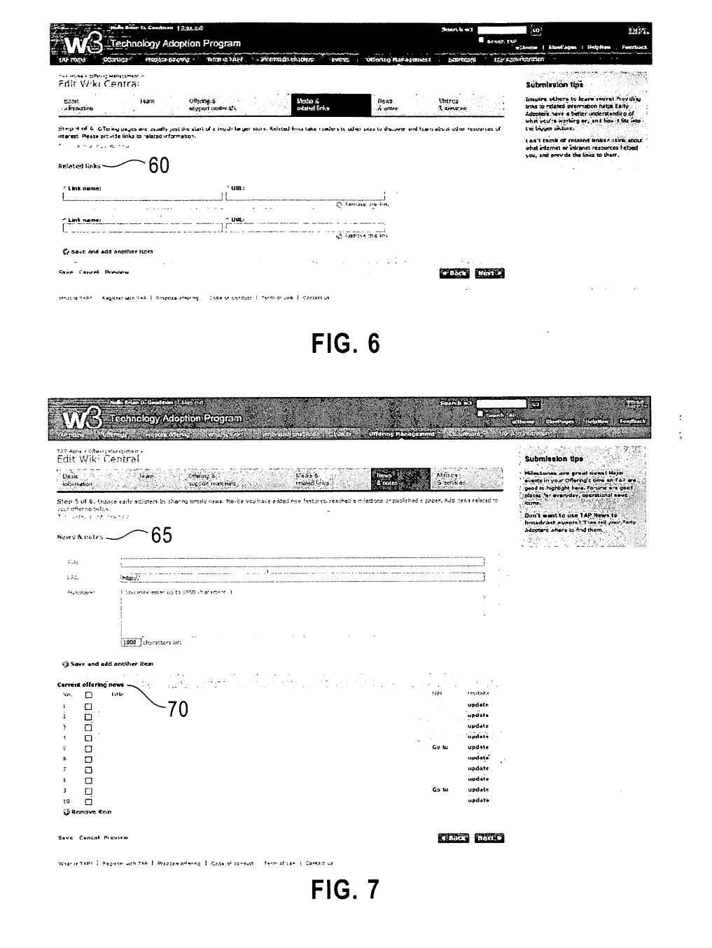

As illustrated in FIG. 5, a Support Materials webpage allows an Innovator to provide links or downloads 55 to access at least one of the Offering, support materials, diagrams, screen shots, downloads, or manuals. As illustrated in FIG. 6, a Media and Related Links webpage allows an Innovator to provide links 60 related to at least one of background information, history, or related resources for the proposed Offering that may be of interest to the TAP community. As illustrated in FIG. 7, a News and Notes webpage allows an Innovator to provide news 65 related to the proposed Offering. A listing of Current News 70 may include, for example, new features, new updates, published papers, or milestones reached for the Offering.

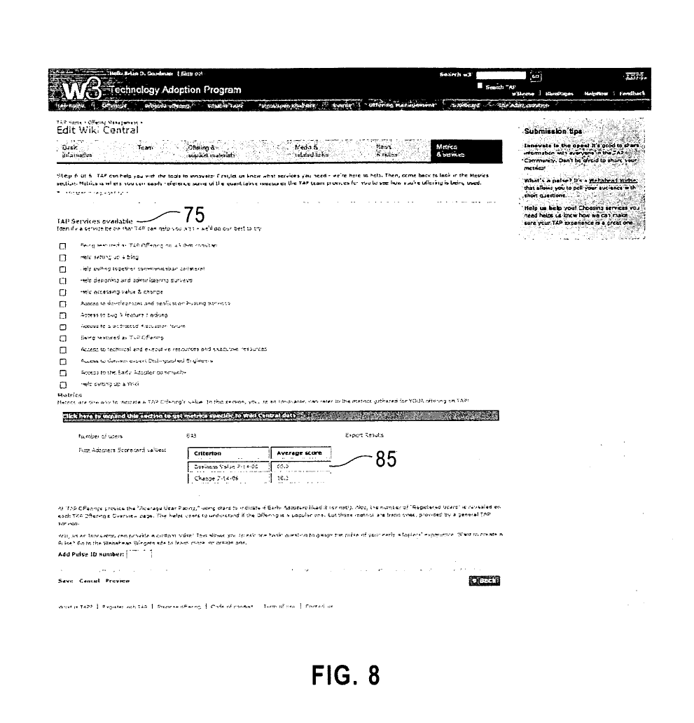

As illustrated in FIG. 8, a Metrics and Services webpage helps Innovators request at least one of services, infrastructure, or tools 75 from the TAP team that they need to develop an Offering. For example, an Innovator may request at least one service or infrastructure including, but not limited to, pulling together communications material; help designing and administering at least one of questionnaires, surveys, or polls; help assessing value and change metrics; help with application hosting services; access to bug tracking; access to technical support; access to executive support; access to executive resources; access to engineers or experts; or access to intellectual property guidance.

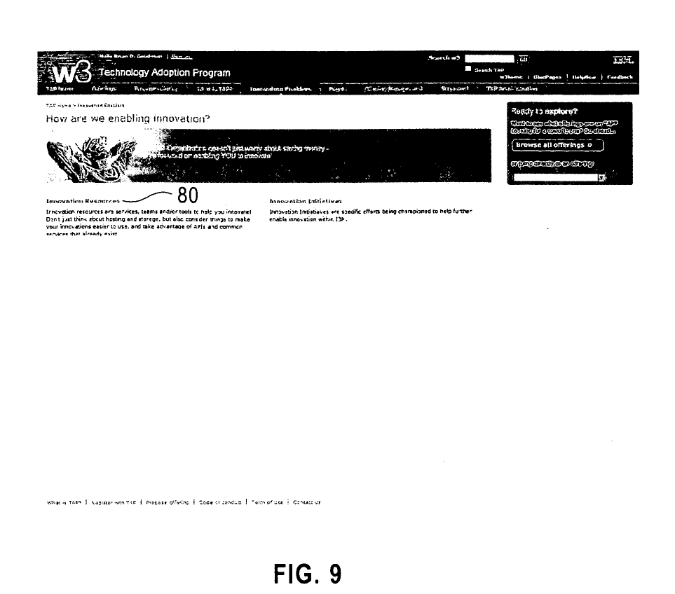

The Innovator may request at least one collaboration tool including, but not limited to, setting up a blog, a wiki, a podcast, a forum (e.g., dedicated discussion forum), audio files, video files, teleconferences, e-mails, instant messaging, questionnaires, surveys, or polling. In embodiments, First Adopters and Early Adopters use the at least one collaboration tool to communicate with an Innovator. Innovators are encouraged to ask questions through these collaboration tools, thereby finding out the problems and issues encountered with an Offering, along with which features and capabilities that are deemed valuable. This feedback allows for Innovators to learn how their project is adding value or what needs to be changed. A separate innovation enablers webpage may provide a detailed description 80 of the resources available to Innovators (FIG. 9).

For example, the application hosting service provides infrastructure options ranging from simple, self-service hosting solutions to a supported enterprise-level hosting environment. In embodiments, IBM's Bluehost is a hosting option that requires little support from the TAP team. Bluehost provides Innovators with a lightweight, easy to use, shared hosting service. A virtualized suite of software tools is available internally based on a “LAMP” (Linux, Apache, MySQL, PHP/Perl) hosting model, commonly available to Internet consumers. Bluehost users may have their own Linux-based Web server, server-side scripting capabilities, and one or more databases. This resource allows Innovators to host their applications quickly and easily, without incurring the complication and overhead of system administration.

In embodiments, the TAP Dynamic Infrastructure Lab (TDIL) is a self-service, user-managed, and dedicated hosting environment. The TAP team can provide a server dedicated to an Innovator's Offering and can easily recover it, recycling it for another Offering. The Innovation Hosting Environment (IHE) is a managed, flexible hosting model that enables rapid, iterative deployments of an Offering. This environment is for those technologies that have proven valuable to Early Adopters, and need a space in which to mature into a formal, supported product. In all three cases, TAP provides funding for the supporting infrastructure, including hardware, network services, and support, thus removing the barriers of cost, time to acquire hardware, and rigid processes.

As also illustrated in FIG. 8, the Metrics and Services webpage may provides metrics 85 as to how an Offering is being used and evaluated. As discussed in more detail below, in embodiments, the Metrics provide the results of Scorecards submitted by First Adopters.

D. Offering Management Webpage

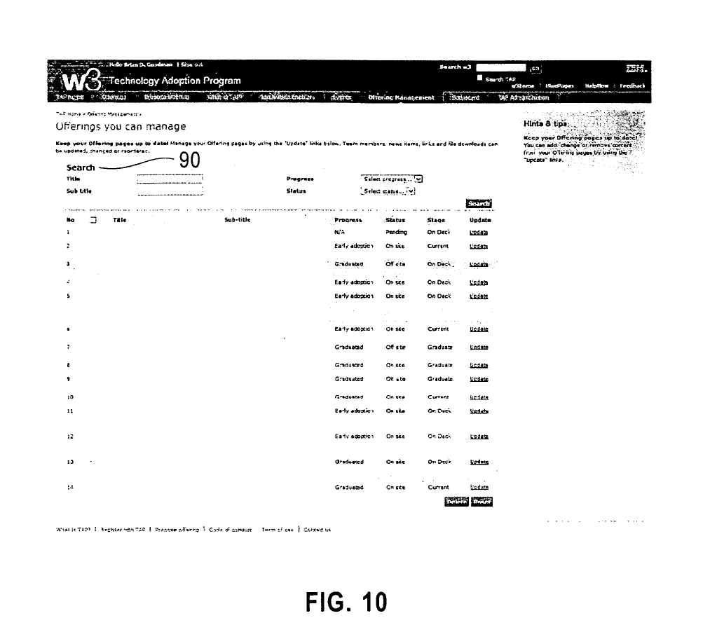

As illustrated in FIG. 10, an Offering Management webpage allows an Innovator to update, change, or reorder information entered in FIGS. 3-8 for an approved Offering as it proceeds through the TAP lifecycle. In embodiments, an offering may be searched 90 by at least one of title, progress, or status.

E. Offerings Webpage

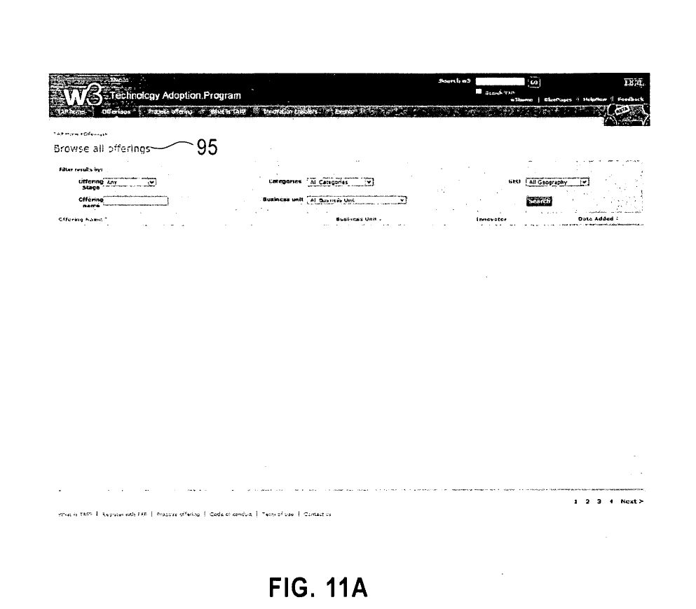

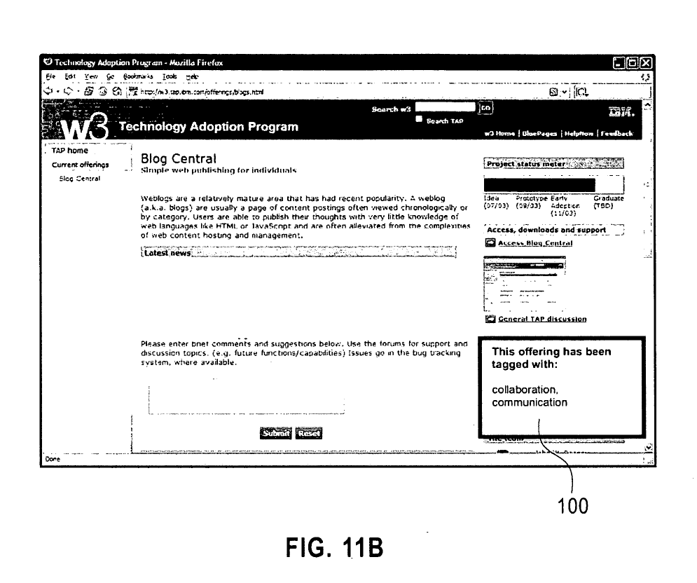

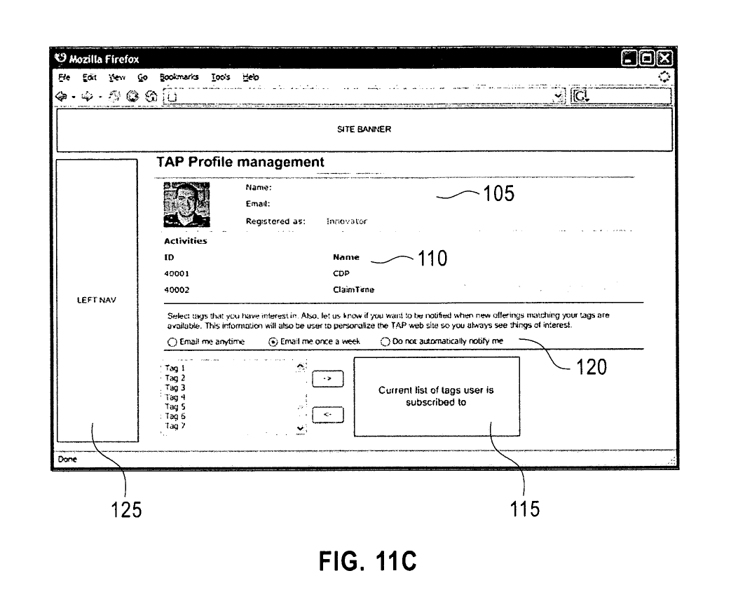

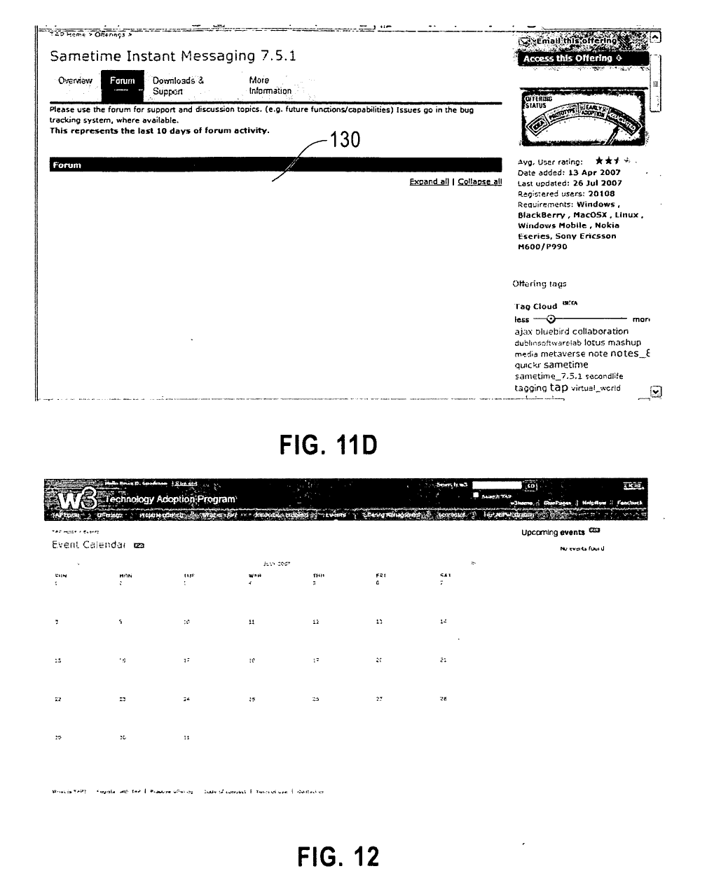

As illustrated in FIG. 11A, an Offerings webpage allows the TAP community to browse or search the Offerings, 95. The Offerings may be browsed or searched by at least one criterion, for example, by name, by category, by business unit, by stage of development, or by geographical location. The Offerings webpage provides a description for each Offering as well as information provided by the Innovator (e.g., Basic Information, Team, Support Materials, Related Links, or News/Notes).

In certain embodiments, an Offering webpage shows tags 100, as illustrated in FIG. 11B. Tags are keywords that are associated with each Offering. An Innovator or the TAP Team may provide initial tags for an Offering. However, the Offerings webpage allows at least one of First Adopters or Early Adopters to add additional tags to an Offering, thereby empowering the TAP community to define the classification for each Offering. In embodiments, a tag may be any unique series of characters or numbers, for example, a user's name, email address, or profile attributes, such as geographic location, whether or not socially applied.

According to the present invention, as illustrated in FIG. 11C, registered TAP users may configure their personal profiles 105 to view the Offerings 110 in which they have participated. In addition, the personal profile may contain a list of tags 115 which a registered user selects as interests. In embodiments, registered users are able to select an automatic email notification feature 120 in which they are notified by email when an Offering becomes available that has been tagged with one of their selected tags. A registered user's selected tags may also be used to display Offerings in a separate bar, for example, a left hand navigation bar 125 on any webpage, thereby allowing easy access to each Offering's webpage.

In embodiments, the Offerings webpage allows access to at least one collaboration tool for an Offering. For example, an Offering's webpage may provide access to a dedicated forum 130 for the Offering, as illustrated in FIG. 11D. The dedicated forum allows at least one of First Adopters or Early Adopters to communicate with an Innovator and is available for the TAP community to see.

F. Events Webpage

As illustrated in FIG. 12, an Events webpage allows members of the TAP Community to schedule events.

G. Evaluation by First Adopters

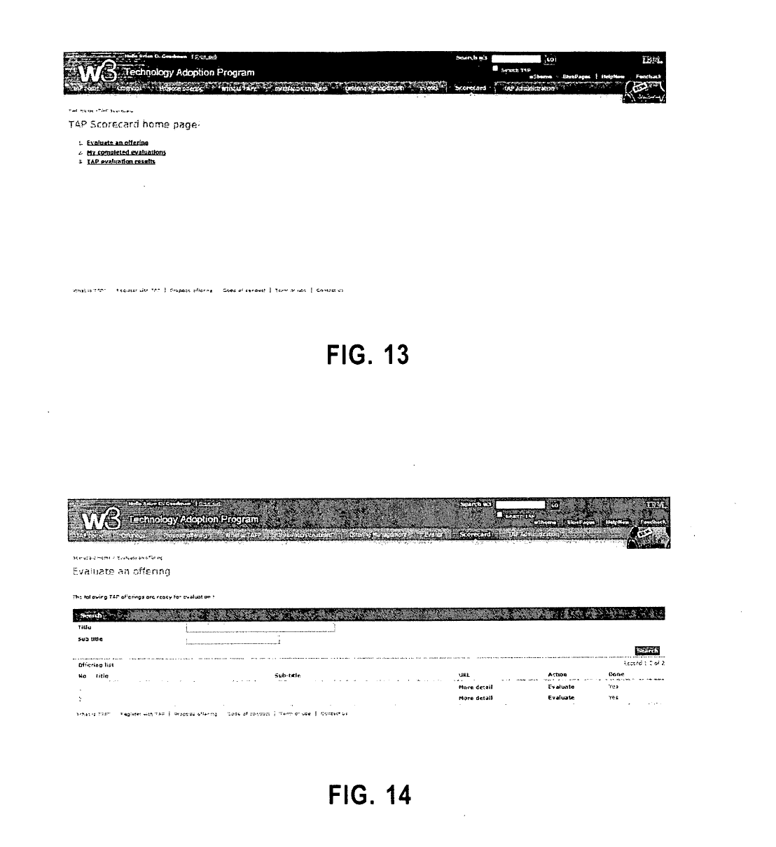

As illustrated in FIG. 13, a Scorecard home webpage allows First Adopters to evaluate an Offering, review completed evaluations, and see evaluation results. An Evaluation webpage indicates which Offerings are ready for evaluation, as illustrated in FIG. 14.

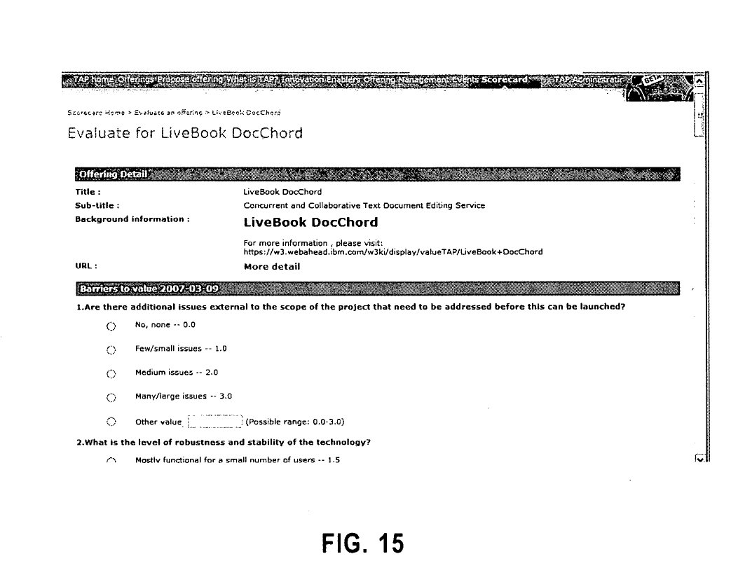

According to the present invention, a Scorecard is used to facilitate evaluation of an Offering by First Adopters, as illustrated in FIG. 15. In embodiments, the Scorecard evaluates an Offering based upon an Offering's Business Value (e.g., stability, ease of use, number of potential users, competing technology) and Change Value (e.g., impact to current enterprise architecture, affect on business processes, funding needed to deploy, barriers). In embodiments, the Scorecard comprises a questionnaire, for example, twenty questions with point rankings. First Adopters may save and edit Scorecards at any time. In embodiments, the Scorecard may be any tool that automatically detects collaborative behavior and generates a score.

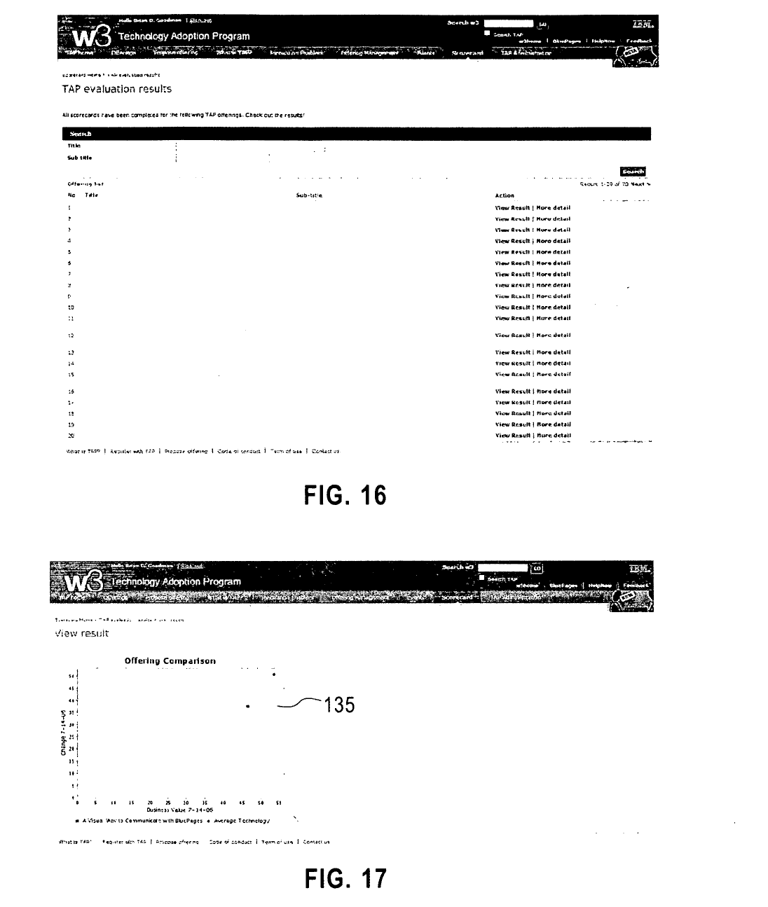

For each Offering, the Scorecards are grouped, and at least one numerical value is calculated based upon the evaluation. In embodiments, the at least one numerical value comprises a mean value for each of the Business Value and Change criteria, for example, on a scale of 1 to 100 (85 in FIG. 8). These measurements are made available on the website, thus providing the first baseline for the TAP Team and Early Adopters to gauge the potential benefits and barriers of an Offering. A list of evaluated Offerings may be available as illustrated in FIG. 16.

In embodiments, the at least one numerical value for two or more Offerings may be compared, for example, in a graph 135 as illustrated in FIG. 17 showing a plot of the Change Value and the Business Value. The at least one numerical value for an Offering may be compared to a Hypothetical Average Offering (i.e., an Offering in which the results of a Scorecard are based upon answers selected between a favorable response and an unfavorable response). The at least one numerical value for an Offering may also be compared to at least one of: (1) the actual results of Scorecards for individual Offerings; (2) the actual average results of Scorecards for all Offerings; or (3) the actual average results of Scorecards for Offerings having selected specific criteria (e.g., software platform, the business unit or organization, technology category, geographical location). For each question presented in a Scorecard, other statistics may be displayed, such as mean, median, average, and standard deviation.

H. Evaluation by Early Adopters

Evaluation by Early Adopters comprises at least one of an informal analysis or formal analysis. The informal analysis is directed to Early Adopter usage of at least one collaboration tool, which is monitored and tracked. For example, for a particular Offering, the number of threads or blog entries, the number of downloads, the number of e-mails, the number of downloads of podcasts, audio files, or video files, the number of edits to a wiki, the number of entries into a dedicated forum, the number of users, or any combination thereof may be measured.

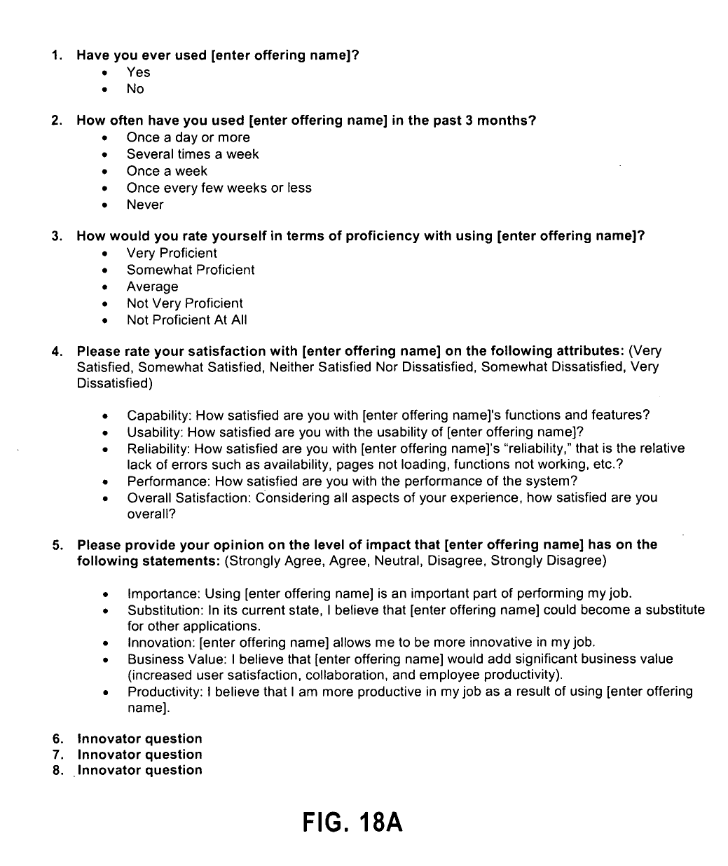

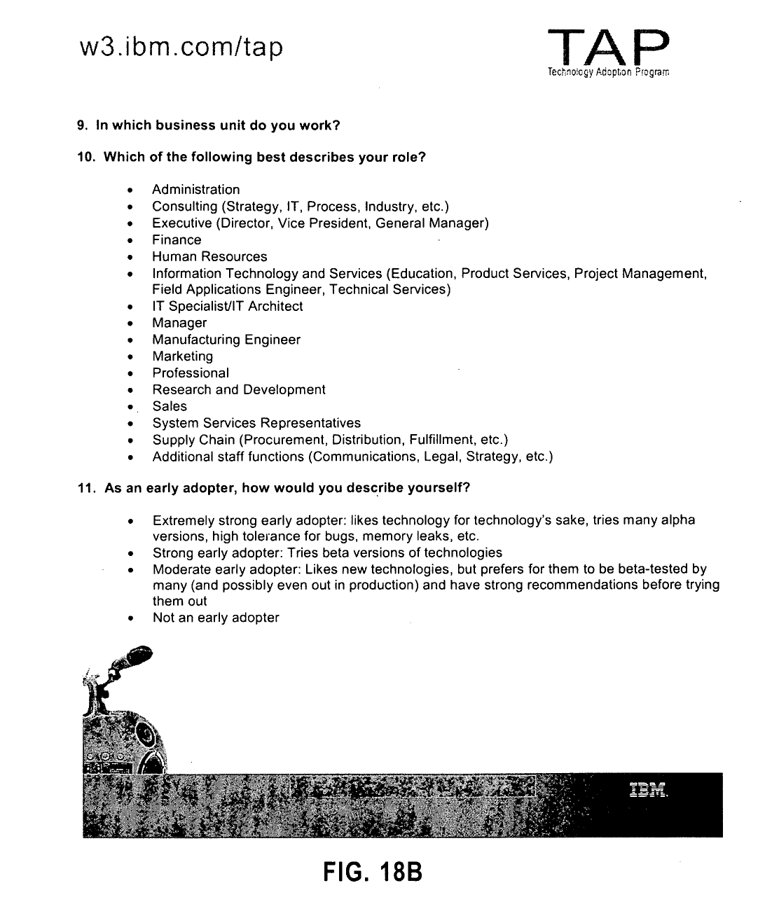

In a formal analysis, Early Adopters are provided with a Survey. In embodiments, the Survey may include a plurality of questions including standard questions for all Offerings and questions provided by an Innovator for a specific Offering, as illustrated in FIGS. 18A-18B. For example, the Survey may comprise 10 questions including 5 standard questions for all Offerings and 5 Offering-specific questions. The questions may be multiple choice, yes or no questions, true or false questions, ratings on a numerical scale, or any combination thereof.

In embodiments, the standard questions directed to all Offerings may include, but are not limited to, questions regarding an Early Adopter's use of an Offering, proficiency with using an Offering, level of satisfaction with an Offering, or level of impact of an Offering (e.g., importance, ability to substitute for other technologies, business value, ability to change productivity, or fostering innovation). The Survey may also collect demographic information about the Early Adopters, such as the business unit in which they work and their title or role within the enterprise.

The Survey may be deployed at any time after an Offering has been through the First Adopters, for example, about 2 months to about 6 months after the Offering has been through the First Adopters. Unlike the Scorecard, the results of Surveys are anonymous and are available only to the TAP Team and to other Administrators.

I. Early Adoption Value

In embodiments, the results from the Scorecards, the measurements of collaboration tool usage, and the results from the Surveys are aggregated and weighted. A single number is calculated (i.e., an Early Adoption Value). In embodiments, the Early Adoption Value comprises a numerical value on a scale from 0 to 100. The Early Adoption Value may be calculated in real-time or at set intervals. The Early Adoption Value is only seen by the TAP Team, Administrators, or other executives.

The Early Adoption Value helps quantify the value of each Offering and ranks all of the Offerings. The ranking of Offerings gives the TAP Team a basis for deciding the future of an Offering. For example, the Early Adoption Value helps decide (1) if an Offering needs additional resources to mature to a production-ready state (e.g., Early Adoption Value greater than 70); (2) if an Offering needs further development and iteration (e.g., Early Adoption Value between 40 and 70); or (3) if an Offering did not add value and should no longer receive development resources (Early Adoption Value less than 40). With this decision, an Offering graduates from TAP.

J. Administration Webpage

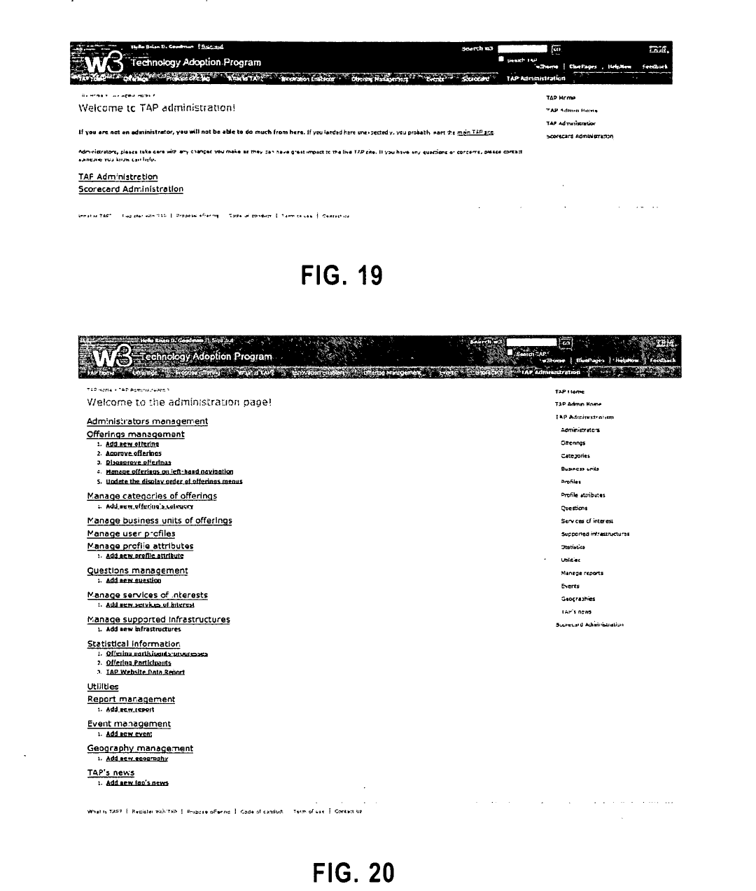

As illustrated in FIGS. 19-20, TAP Administration webpages provide a variety of functions for the TAP Team or other Administrators. The TAP Administration webpage allows for at least one of review and approval or disapproval of Offerings, view and manage at least one of categories of Offerings, services and tools that supports Innovators, statistical information, events, news, Scorecards, Surveys, or personal profiles.

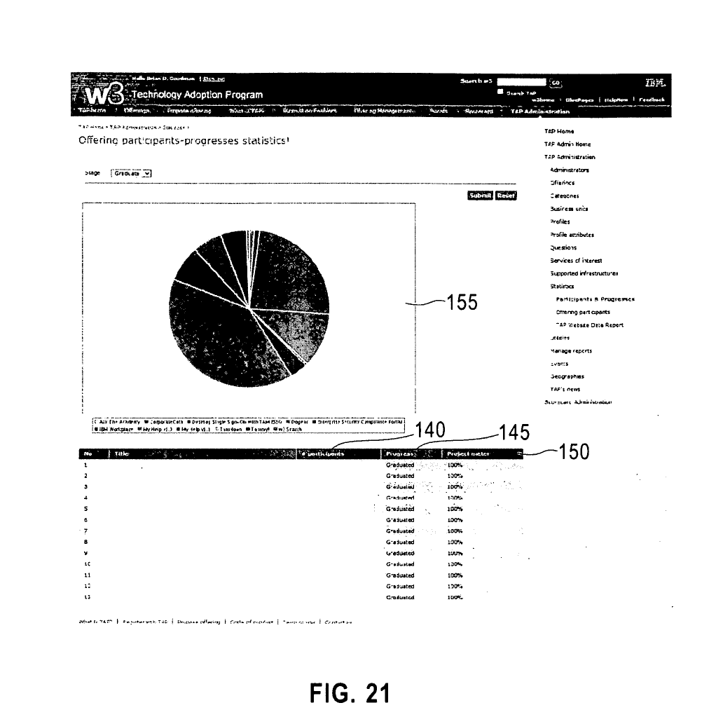

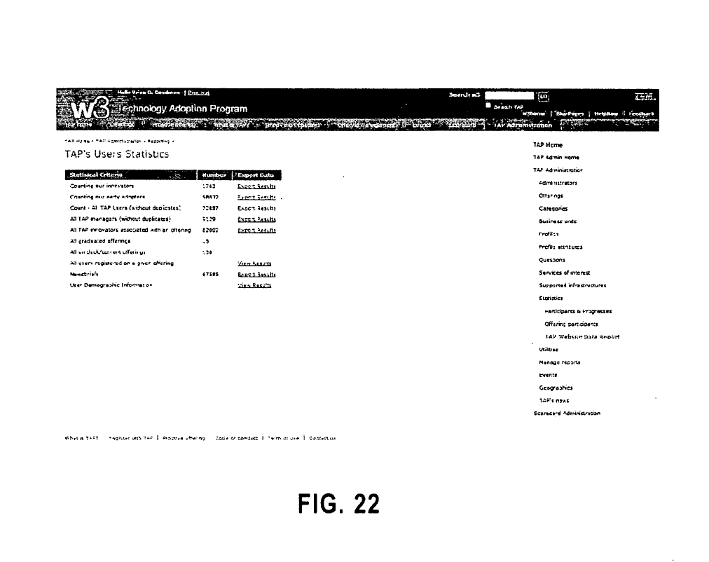

In embodiments, the TAP Administration webpages may show statistical information. As illustrated in FIG. 21, each Offering's progress through TAP may be displayed, for example, showing the number of participants 140, the process through the TAP lifecycle 145, and the percentage of completion 150, for example as a metered bar. Data on Offerings may be viewed as a pie chart 155. Statistical information may also provide data on all registered TAP users (FIG. 22).

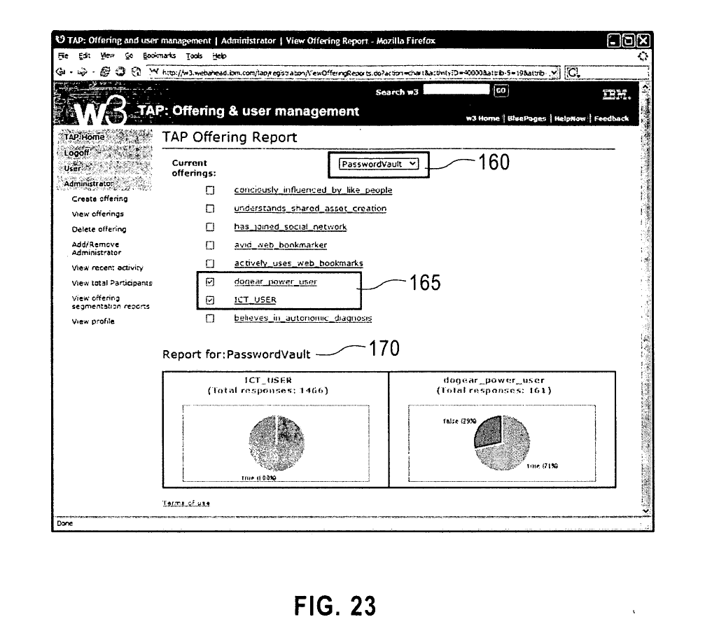

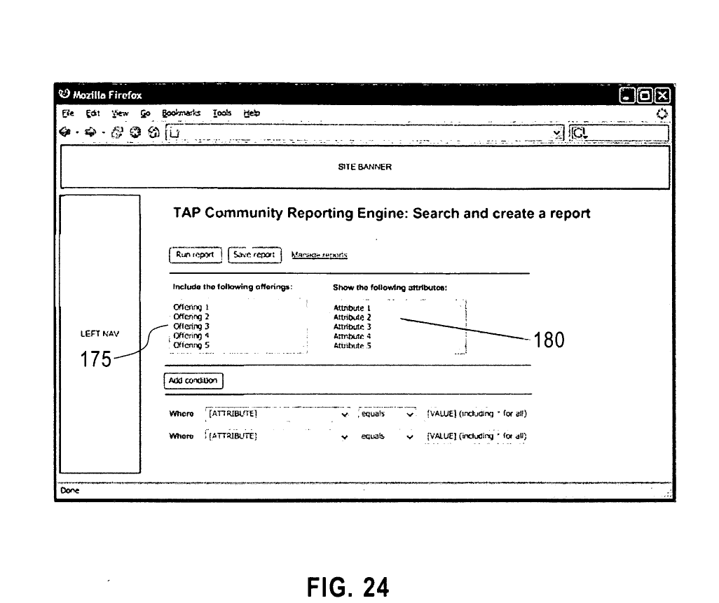

In embodiments, the TAP Administration webpages may allow for dynamic list creation, as illustrated in FIGS. 23-24. Thus, the TAP Team or Administrators may perform a variety of queries to create dynamic lists and rich reporting data. Dynamic list creation allows the TAP team to contact segments of the TAP community in a flexible manner. A list that is created may be saved and downloaded, for example, in spreadsheet or PDF format, for future access.

According to the present invention, Offering Segmentation Reports allow a better understanding of connections and interrelationships between Innovators, First Adopters, and Early Adopters of a variety of Offerings. For example, as illustrated in FIG. 23, an Offering 160 (e.g., PasswordVault) may be selected and filtered based upon which users also are registered with other Offerings 165 (e.g., Dogear and ICT). The resulting dynamic report 170 may show the filtered data in a pie chart or other graphical manner. In embodiments, queries may be performed not just for specific Offerings, but also across all registered TAP users.

According to an embodiment of the present invention, the TAP team or an Administrator may create a report or list based upon a specific Offering 175 and a set of attributes 180, as illustrated in FIG. 24. Attributes may include, but are not limited to, at least one of user type (e.g., Innovator, Early Adopter); Offerings; or specific criteria (e.g., software platform, the business unit or organization, technology category, geographical location, job role) and may be limited through mathematical or logical operators.

For example, an Administrator may select all users that participated in an Offering and limit the results based upon at least one attribute (e.g., those users who have not join a social networking community). The resulting report may include a summary of the query and the data for each of the attributes selected. In embodiments, the results may be displayed in a graph, bar chart, or pie chart.

### IV. System

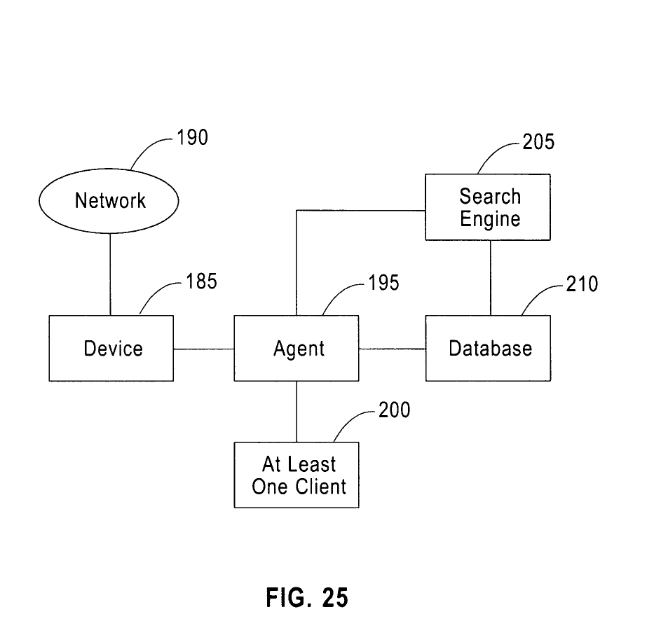

FIG. 25 is a block diagram showing an illustrative system of the invention. The illustrative system includes at least one electronic or digital device 185 (e.g., a personal computer, cellular telephone, personal digital assistant or PDA, game device, MP3 player, television). The at least one device may be connected to a network 190 (e.g., the internet, World Wide Web, intranet, local area network (LAN), wide area network (WAN)).

In embodiments, the system includes an agent 195 for providing a website for a technology adoption program or process (TAP) and allowing access to at least one offering for a new technology; at least one client 200; a search engine 205; and at least one database 210 for storing input, edits, lists, and reports generated by the TAP community using the website and its related webpages. The agent and at least one client may be applications residing on the at least one electronic or digital device. The search engine may be any search engine capable of locating files or data, for example, Yahoo® or Google® search engines. The illustrative system is but one example, and one of ordinary skill in the art would recognize that many other variations may exist, all of which are contemplated by the invention.

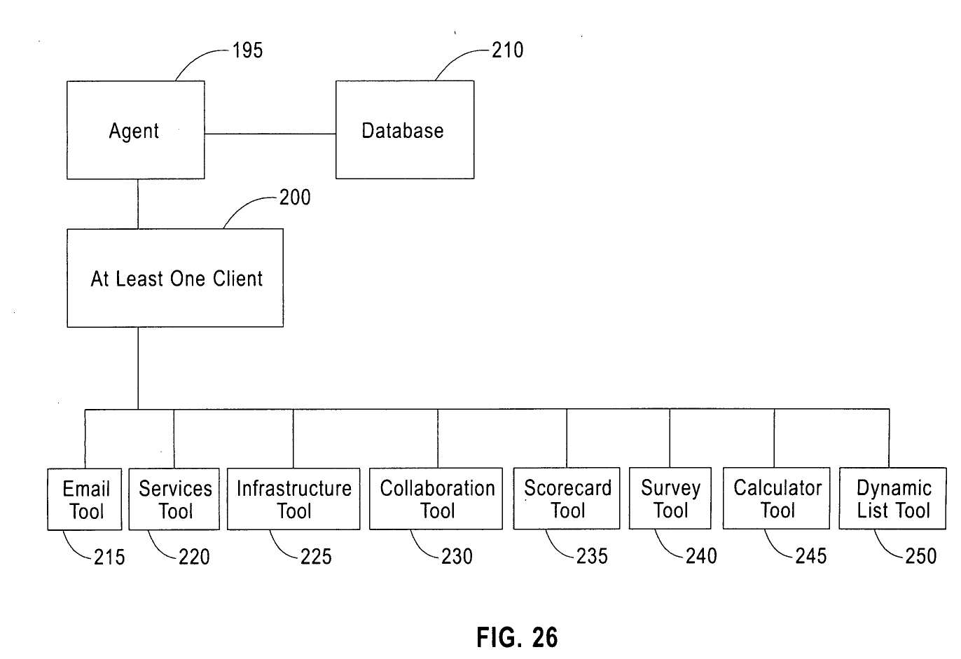

FIG. 26 illustrates an exemplary agent of the invention. The agent 195 includes at least one client 200 comprising at least one of (1) an Email tool 215; (2) a Services tool 220, (3) an Infrastructure tool 225, (4) a Collaboration tool 230, (5) Scorecard tool 235, (6) a Survey tool 240, (7) a Calculator tool 245, (8) a Dynamic List tool 250, or any combination thereof.

The Email tool 215 solicits a group of First Adopters to use the at least one Offering and provides automatic email notification of new Offerings according to selected tags in registered users' profiles. The Services tool 220 provides Innovators with services to develop their Offerings. Service may include pulling together communications material; help designing and administering at least one of questionnaires, surveys, or polls; help assessing value and change metrics; bug tracking; access to technical support; access to executive support; access to executive resources; access to engineers or experts; or access to intellectual property guidance. The Infrastructure tool 225 provides Innovators with infrastructure to develop their Offerings, for example, at least one of servers or software. The Collaboration tool 230 provides Innovators with at least one of a blog, a wiki, a podcast, a forum, audio files, video files, teleconferences, e-mails, instant messaging, or polling for interactive communication between Innovators and a group of adopters (e.g., First Adopters and Early Adopters) of an Offering.

The Scorecard tool 235 provides a Scorecard to facilitate evaluation of an Offering by a group of First Adopters. The Survey tool 240 provides a survey to evaluate an Offering by a group of Early Adopters. The Calculator tool 245 calculates at least one numerical value (e.g., Business Value and Change Value) from results of a Scorecard. In embodiments, the Calculator tool may calculate a single numerical value (Early Adoption Value) based on the results of a scorecard; the results of a survey; and measurements of the use of at least one collaboration tool. The Dynamic List tool 250 provides for the ability to perform a variety of queries and to create dynamic reports or lists by searching the at least one database.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of at least one general purpose computer, special purpose computer(s), or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

1. A method for technology evaluation and adoption, comprising:
proposing a new technology;
allowing at least one group to use the new technology, said at least one group providing feedback through at least one collaboration tool;
evaluating the at least one group's use of the new technology; and
calculating at least one value based upon said evaluating.

2. A method according to claim 1, wherein the new technology comprises at least one of new software, programs, services, or business processes.

3. A method according to claim 1, wherein the at least one collaboration tool comprises a forum, blog, wiki, podcast, audio file, video file, teleconference, e-mail, instant messaging, questionnaires, surveys, or polling.

4. A method according to claim 1, wherein the at least one collaboration tool comprises a forum.

5. A method according to claim 1, wherein evaluating the at least one group's use of the new technology comprises providing a scorecard.

6. A method according to claim 5, wherein calculating at least one value based upon said evaluating comprises calculating a business value and a change value from results of the scorecard.

7. A method according to claim 1, comprising:
allowing a first group and a second group to use the new technology, each group providing feedback through at least one collaboration tool; and
evaluating the first and second group's use of the new technology.

8. A method according to claim 7, wherein evaluating the second group's use of the new technology comprises providing a survey comprising standard questions and questions related to the new technology.

9. A method according to claim 8, wherein evaluating the second group's use of the new technology further comprises monitoring the second group's use of the at least one collaboration tool.

10. A method according to claim 7, further comprising calculating a single value based upon evaluating the first and second groups' use of the new technology.

11. A method according to claim 1, further comprising associating at least one tag with the new technology.

12. A method according to claim 11, further comprising providing email notification of offerings based upon a user's subscription to at least one tag.

13. A method for evaluating technology, comprising:
an innovator proposing an offering for a new technology through a website;
a team reviewing the offering and, upon approval, providing a webpage directed to the offering;
a group of first adopters accessing and using the new technology and providing feedback to the innovator through at least one collaboration tool;
evaluating the first adopters' use of the offering; and
calculating at least one numerical value based upon the evaluation of the first adopters.

14. A method according to claim 13, wherein the offering for a new technology comprises at least one of new software, programs, services, or business processes.

15. A method according to claim 13, wherein the at least one collaboration tool comprises a forum, blog, wiki, podcast, audio file, video file, teleconference, e-mail, instant messaging, questionnaires, surveys, or polling.

16. A method according to claim 13, wherein the innovator requests at least one of services, infrastructure, or tools from the team to develop the offering.

17. A method according to claim 13, wherein evaluating the first adopters' use of the offering comprises:
providing a scorecard; and
calculating at least one numerical value from results of the scorecard.

18. A method according to claim 13, further comprising:
a group of early adopters accessing and using the new technology and providing feedback to the innovator through at least one collaboration tool;
evaluating the early adopters' use of the offering; and
calculating a single numerical value based upon the evaluation of the first adopters and the evaluation of the early adopters.

19. A method according to claim 18, wherein evaluating the early adopters' use of the new technology comprises:
providing a survey to the early adopters; and
monitoring the early adopters' use of the at least one collaboration tool.

20. A method according to claim 17, further comprising comparing the at least one numerical value for one offering to the at least one numerical value for a second offering.

21. A method according to claim 17, further comprising comparing the at least one numerical value for one offering to the at least one numerical value for an average offering.

22. A method for evaluating technology, comprising:
an innovator submitting an offering for a new technology through a website;
a team reviewing the offering and, upon approval, providing a webpage directed to the offering;
a group of first adopters accessing and using the new technology and providing feedback to the innovator through at least one collaboration tool;
evaluating the first adopters' use of the offering;
a group of early adopters accessing and using the new technology and providing feedback to the innovator through at least one collaboration tool;
evaluating the early adopters' use of the offering;
calculating a single value based upon the evaluation of the first adopters and the early adopters.

23. A system for technology evaluation and adoption, comprising:
an agent for providing a website and allowing access to at least one offering for a new technology;
at least one client;
a search engine; and
at least one database for storing at least one of input, edits, lists or reports generated by use of the website.

24. A system according to claim 23, wherein the at least one client comprises at least one of an Email tool; a Services tool, an Infrastructure tool, a Collaboration tool, a Scorecard tool, a Survey tool, a Calculator tool, a Dynamic List tool, or any combination thereof.

25. A computer program product,
a computer useable medium having a computer readable program, wherein the computer readable program when executed on a computer causes the computer to:
propose a new technology;
allow at least one group to use the new technology, said group providing feedback through at least one collaboration tool;
evaluate the at least one group's use of the new technology; and
calculate at least one value based upon said evaluation.
